(19) United States
(12) Patent Application Publication
(10) Pub. No.: US 2017/0002840 A1
(43) Pub. Date: Jan. 5, 2017

(54) FLUID PRESSURE SYSTEM, PRESSURE ACCUMULATION METHOD OF ACCUMULATOR, AND OPERATION METHOD OF FLUID PRESSURE ACTUATOR

(71) Applicant: KYB CORPORATION, Tokyo (JP)

(72) Inventor: Yoshihiro OOBAYASHI, Kanagawa (JP)

(73) Assignee: KYB Corporation, Tokyo (JP)

(21) Appl. No.: 15/125,627

(22) PCT Filed: Jun. 3, 2015
(86) PCT No.: PCT/JP2015/066090

§ 371 Date: Sep. 13, 2016

(30) Foreign Application Priority Data
Jun. 6, 2014 (JP) 2014-118102

(51) Int. Cl. F15B 1/027

(52) U.S. Cl. CPC F15B 1/027

(57) ABSTRACT

A fluid pressure system includes a first fluid pressure pump configured to discharge a working fluid that operates fluid pressure actuators, a second fluid pressure pump provided in parallel to the first fluid pressure pump and configured to discharge a working fluid, an accumulator capable of accumulating the working fluid discharged from the second fluid pressure pump, and a first switching valve configured to supply the working water accumulated in the accumulator to the fluid pressure actuator when the first switching valve is switched to an opened state.

### TECHNICAL FIELD

The present invention relates to a fluid pressure system, an accumulation method of an accumulator, and an operation method of a fluid pressure actuator.

### BACKGROUND ART

A fluid pressure system in which a fluid pressure actuator is operated using a pressure of working fluid accumulated in an accumulator is used conventionally.

JP2010-105014A discloses a charging method of an accumulator of accumulating pressurized working oil in an accumulator for operating an injection cylinder of a die-casting machine. This charging method includes an accumulating step of stopping supply of the pressurized working oil from a hydraulic pump to the injection cylinder by switching a flow rate control valve and accumulating the pressurized working oil in the accumulator.

### SUMMARY OF INVENTION

According to the charging method of JP2010-105014A, the pressurized working oil from the hydraulic pump is guided to the accumulator by switching the flow rate control valve. Therefore, during a period when the working oil from the hydraulic pump is accumulated in the accumulator, the injection cylinder cannot be operated.

It is therefore an object of the present invention to make accumulation in an accumulator while operating an actuator.

According to an embodiment of the present invention, a fluid pressure system of supplying a working fluid comprises a first fluid pressure pump configured to discharge a working fluid to operate a fluid pressure actuator, an accumulator capable of accumulating the working fluid discharged from the second fluid pressure pump, and a first switching valve configured to supply the working fluid accumulated in the accumulator to the fluid pressure actuator when the first switching valve is switched to an open state.

According to a further embodiment of the present invention, an operation method of a fluid pressure actuator comprises supplying a working fluid discharged from a first fluid pressure pump to the fluid pressure while accumulating a working fluid discharged from a second fluid pressure pump which is provided in parallel to the first fluid pressure pump in an accumulator, operating the fluid pressure actuator in one direction by supplying the working fluid discharged from the first fluid pressure pump to the fluid pressure actuator, and operating the fluid pressure actuator in another direction by supplying the working fluid accumulated in the accumulator.

The details as well as other features and advantages of the present invention are set forth in the remainder of the specification and are shown in the accompanying drawing.

### BRIEF DESCRIPTION OF DRAWING

FIG. 1 is a circuit diagram of a fluid pressure system according to an embodiment of the present invention.

### DESCRIPTION OF EMBODIMENTS

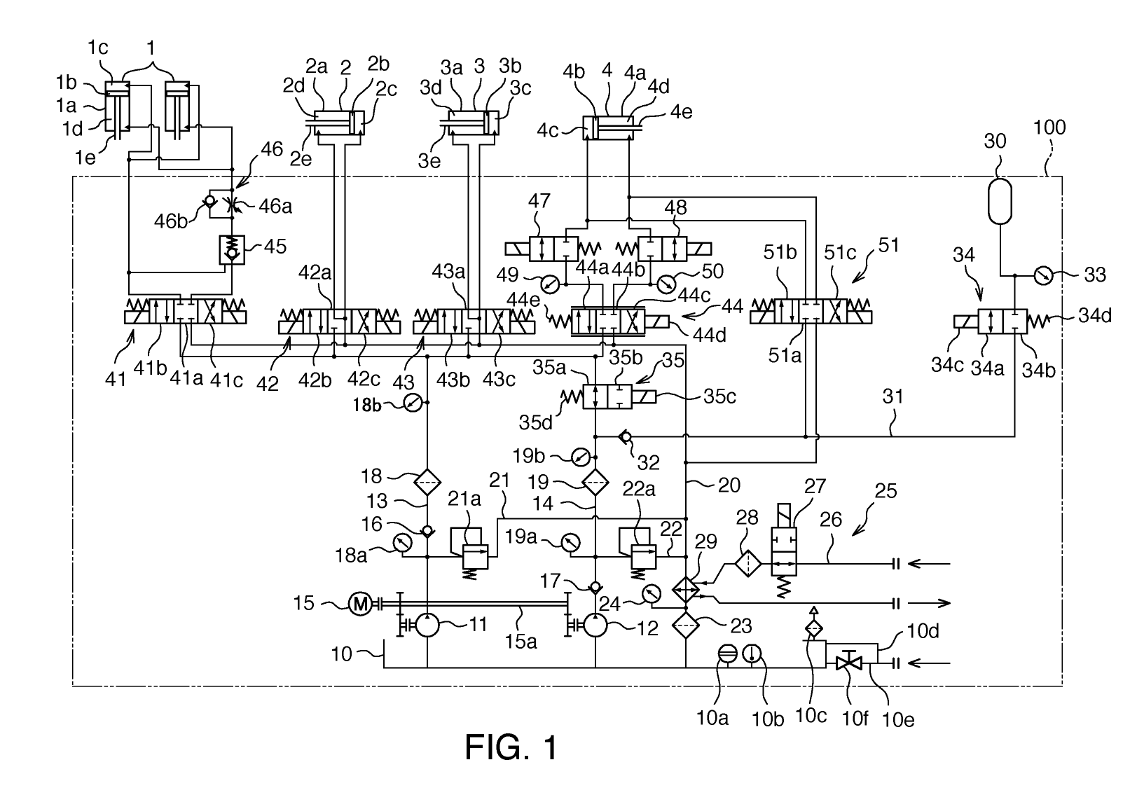

Referring to FIG. 1 of drawing, a water pressure system 100 serving as a fluid pressure system according to an embodiment of the present invention will be described.

The water pressure system 100 is configured to supply a working water to operate water pressure cylinders 1 to 4 serving as fluid pressure actuators. In the water pressure system 100, the working water is used as a working fluid. It should be noted, however, the working fluid according to the present invention is not limited to the working water, but other fluids such as working oil and compressed air may be used as the working fluid.

Firstly, a configuration of the water pressure cylinders 1 to 4 will be described.

A pair of water pressure cylinders 1 that extends and contracts in synchronization with each other is provided. Each of the pair of water pressure cylinders 1 includes a cylinder main body 1a, a piston 1b defining a piston side chamber 1c and a rod side chamber 1d in the cylinder main body 1a, and a piston rod 1e provided integrally with the piston 1b and extended to an exterior of the cylinder main body 1a.

Similarly, the water pressure cylinders 2 to 4 respectively include cylinder main bodies 2a-4a, pistons 2b-4b defining piston side chambers 2c-4c and rod side chambers 2d-4d in the cylinder main bodies 2a-4a, and piston rods 2e-4e provided integrally with the pistons 2b-4b and extended to exteriors of the cylinder main bodies 2a-4a.

In the water pressure cylinders 1 to 4, when the working water is supplied to the piston side chambers 1c-4c in a state where the rod side chambers 1d-4d communicate with a tank 10, the piston rods 1e to 4e are retreated from the cylinder main bodies 1a to 4a and extended. Meanwhile, in the water pressure cylinders 1 to 4, when the working water is supplied to the rod side chambers 1d-4d in a state where the piston side chambers 1c-4c communicate with the tank 10, the piston rods 1e to 4e are brought into the cylinder main bodies 1a to 4a and contracted. In such a way, the water pressure cylinders 1 to 4 are double-acting type cylinders.

In place of the water pressure cylinders 1 to 4, other actuators such as water pressure motors may be used as the fluid pressure actuator. In the present embodiment, the four sets of water pressure cylinders 1 to 4 are provided. The number of the actuators operated by the system is, however, not limited to this, but the system may have at least one or more actuators to operate.

Next, a configuration of the water pressure system 100 will be described.

The water pressure system 100 includes a water pressure pump 11 serving as a first fluid pressure pump configured to discharge a working water, a water pressure pump 12 serving as a second fluid pressure pump provided in parallel with the water pressure pump 11 and configured to discharge a working water, and an accumulator 30 capable of accumulating the working water discharged from the water pressure pump 12.

The water pressure pump 11 suctions the working water from the tank 10 and discharges the working water to a supply passage 13. The water pressure pump 12 suctions the working water from the tank 10 and discharges the working water to a supply passage 14. The water pressure pump 11 and the water pressure pump 12 are driven by a single electric motor 15 via a power transmission mechanism 15a formed by gears, shafts, and the like.

The working water discharged from the water pressure pump 11 is used for operation of the water pressure cylinders 1 to 4. The working water discharged from the water pressure pump 12 is used for the operation of the water pressure cylinders 1 to 4 or accumulation of the accumulator 30 by opening and closing of an on/off valve 35 to be described later. Thereby, by operating the water pressure pump 11 and the water pressure pump 12 together by the electric motor 15, the accumulation can be made in the accumulator 30 while operating the water pressure cylinders 1 to 4.

The tank 10 includes a liquid level meter 10a configured to detect a water level of the working water, a water temperature meter 10b configured to detect a temperature of the working water, and an air breather 10c configured to supply and discharge the air inside the tank 10 when the water level is changed to adjust pressure within a set range. A supply passage 10d through which the working water is supplied from an exterior and a discharge passage 10e provided with a manual on/off valve 10f through which the working water can be discharged are coupled to the tank 10.

The supply passage 13 has a check valve 16 configured to prevent a back flow of the working water discharged from the water pressure pump 11, and a filter 18 configured to remove foreign substances such as contaminants from the working water. The supply passage 14 has a check valve 17 configured to prevent a back flow of the working water discharged from the water pressure pump 12, a filter 19 configured to remove foreign substances such as contaminants from the working water, and the on/off valve 35 serving as a second switching valve provided in the supply passage 14 which provides communication between the water pressure pump 12 and the water pressure cylinders 1 to 4.

On the upstream and the downstream of the filter 18, a water pressure meter 18a and a water pressure meter 18b are provided. Similarly, on the upstream and the downstream of the filter 19, a water pressure meter 19a and a water pressure meter 19b are provided. Thereby, a pressure difference of the working water between the upstream and the downstream of the filters 18, 19 can be detected, so that clogging of the filters 18, 19 can be detected.

A relief passage 21 having a relief valve 21 a for maintaining the pressure of the working water lower than set pressure is connected to the supply passage 13. The relief passage 21 is connected to a return passage 20 through which the working water discharged from the water pressure cylinders 1 to 4 is returned to the tank 10. Similarly, a relief passage 22 having a relief valve 22a for maintaining the pressure of the working water lower than set pressure is coupled to the supply passage 14. The relief passage 22 is coupled to the return passage 20.

The return passage 20 has a filter 23 configured to remove foreign substances such as contaminants from the working water discharged from the water pressure cylinders 1 to 4, and a water pressure meter 24 provided on the upstream of the filter 23 and configured to detect clogging of the filter 23. A cooling circuit 25 of cooling the working water is provided in the return passage 20.

The cooling circuit 25 has a circulation passage 26 through which a cooling water is circulated, an on/off valve 27 configured to stop circulation of the cooling water when it is switched to a closed state, a filter 28 configured to remove foreign substances such as contaminants from the cooling water, and a heat exchanger 29 configured to cool the working water by exchanging heat between the working water flowing through the return passage 20 and the cooling water.

The on/off valve 35 is provided in parallel to a switching valve 51 to be described later. The on/off valve 35 has a communication position 35a at which communication is provided to the supply passage 14, and a blocking position 35b at which the supply passage 14 is blocked. This communication position 35a corresponds to an opened state, and the blocking position 35b corresponds to a closed state. The on/off valve 35 has a solenoid 35c and is switched by a controller not shown. When an electric signal from the controller is not input to the solenoid 35c, the on/off valve 35 is maintained at the communication position 35a by biassing force of a return spring 35d.

When the on/off valve 35 is in the communication position 35a, the working water discharged from the water pressure pump 12 can be supplied to the water pressure cylinders 1 to 4. When the on/off valve 35 is switched to the blocking position 35b, the working water discharged from the water pressure pump 12 can be supplied to the accumulator 30.

The accumulator 30 is a container in which the pressurized working water is stored. The accumulator 30 is provided in a branch passage 31 branching from the supply passage 14 of the working water discharged from the water pressure pump 12. The accumulator 30 has a balloon shape bladder not shown in which a nitrogen gas is charged.

When the pressure of the working water in the branch passage 31 is boosted in comparison to pressure of the nitrogen gas in the bladder, the accumulator 30 stores a volume of the working water corresponding to a volume of the compressed nitrogen gas in the bladder. When the pressure of the working water in the branch passage 31 is lowered in comparison to the pressure of the nitrogen gas in the bladder, the accumulator 30 discharges the stored working water by the pressure of the nitrogen gas in the bladder. The accumulator 30 can supply a great amount of the working water in a short time in comparison to the water pressure pumps 11, 12.

The branch passage 31 branches from the upstream of the on/off valve 35 in the supply passage 14. A check valve 32 configured to prevent the working water from flowing backward to the supply passage 14, a pressure meter 33 for detecting the pressure of the working water stored in the accumulator 30, and an on/off valve 34 serving as a third switching valve configured to open and close the branch passage 31 communicating with the accumulator 30 are provided in the branch passage 31.

The on/off valve 34 has a communication position 34a at which communication is provided to the branch passage 31, and a blocking position 34b at which the branch passage 31 is blocked. This communication position 34a corresponds to an opened state, and the blocking position 34b corresponds to a closed state. The on/off valve 34 has a solenoid 34c and is switched by the controller. When an electric signal from the controller is not input to the solenoid 34c, the on/off valve 34 is maintained at the blocking position 34b by biassing force of a return spring 34d.

The on/off valve 34 is switched in conjunction with the on/off valve 35. Specifically, the on/off valve 34 is switched to the blocking position 34b when the on/off valve 35 is switched to the communication position 35a, and switched to the communication position 34a when the on/off valve 35 is switched to the blocking position 35b.

The water pressure system 100 includes a switching valve 41 for operating the pair of water pressure cylinders 1, a switching valve 42 for operating the water pressure cylinder 2, a switching valve 43 for operating the water pressure cylinder 3, a water pressure servo valve 44 for operating the water pressure cylinder 4, and the switching valve 51 serving as a first switching valve also for operating the water pressure cylinder 4.

The switching valve 41 is an electromagnetic switching valve of four ports and three positions in which solenoids and centering springs are provided in both ends. The switching valve 41 has a neutral position 41a, a first communication position 41b to which the switching valve is switched when one of the solenoids is electrified, and a second communication position 41c to which the switching valve is switched when the other solenoid is electrified. In a state where both the pair of solenoids is not electrified, the switching valve 41 is held in the neutral position 41a by biassing force of the centering springs. The switching valve 41 is of a closed center type in which all the ports are brought into a closed state at the neutral position 41a.

When the switching valve 41 is switched to the first communication position 41b, the switching valve supplies the working water discharged from the water pressure pump 11 or the working waters discharged from the water pressure pump 11 and the water pressure pump 12 to the piston side chambers 1c of the water pressure cylinders 1 and provides communication between the rod side chambers 1d and the tank 10. Accordingly, in the water pressure cylinders 1, the piston rods 1e are retreated from the cylinder main bodies 1a and extended.

Between the switching valve 41 and the rod side chambers 1d, a pilot check valve 45 and a slow return check valve 46 are provided. When the switching valve 41 is switched to the first communication position 41b, the pilot check valve 45 is brought into an opened state by the pressure of the working water guided to the piston side chambers 1c. Accordingly, the working water in the rod side chambers 1d is guided to the tank 10 through a throttle valve 46a of the slow return check valve 46. Since a flow rate of the working water is reduced by the throttle valve 46a, the water pressure cylinders 1 are slowly extended by meter-out control.

Meanwhile, when the switching valve 41 is switched to the second communication position 41c, the switching valve supplies the working water discharged from the water pressure pump 11 or the working waters discharged from the water pressure pump 11 and the water pressure pump 12 to the rod side chambers 1d of the water pressure cylinders 1 and provides communication between the piston side chambers 1c and the tank 10. At this time, the pilot check valve 45 is brought into an opened state by the pressure of the working water guided to the rod side chambers 1d and a check valve 46b of the slow return check valve 46 is also brought into an opened state. Thereby, in the water pressure cylinders 1, the piston rods 1e are brought into the cylinder main bodies 1a and contracted.

The switching valve 42 is an electromagnetic switching valve of four ports and three positions in which solenoids and centering springs are provided in both ends. The switching valve 42 has a neutral position 42a, a first communication position 42b to which the switching valve is switched when one of the solenoids is electrified, and a second communication position 42c to which the switching valve is switched when the other solenoid is electrified. In a state where both the pair of solenoids is not electrified, the switching valve 42 is held in the neutral position 42a by biassing force of the centering springs. The switching valve 42 is of an exhaust center type in which the piston side chamber 2c and the rod side chamber 2d of the water pressure cylinder 2 communicate with the tank 10 through the return passage 20 at the neutral position 42a.

The switching valve 42 switched to the first communication position 42b supplies the working water discharged from the water pressure pump 11 or the working waters discharged from the water pressure pump 11 and the water pressure pump 12 to the rod side chamber 2d of the water pressure cylinder 2 and provides communication between the piston side chamber 2c and the tank 10. Accordingly, in the water pressure cylinder 2, the piston rod 2e is brought into the cylinder main body 2a and contracted.

Meanwhile, the switching valve 42 switched to the second communication position 42c supplies the working water discharged from the water pressure pump 11 or the working waters discharged from the water pressure pump 11 and the water pressure pump 12 to the piston side chamber 2c of the water pressure cylinder 2 and provides communication between the rod side chamber 2d and the tank 10. Accordingly, in the water pressure cylinder 2, the piston rod 2e is retreated from the cylinder main body 2a and extended.

The switching valve 43 is an electromagnetic switching valve of four ports and three positions in which solenoids and centering springs are provided in both ends. The switching valve 43 has a neutral position 43a, a first communication position 43b to which the switching valve is switched when one of the solenoids is electrified, and a second communication position 43c to which the switching valve is switched when the other solenoid is electrified. Since the switching valve 43 has the same configuration as that of the switching valve 42, detail description thereof is herein omitted.

The water pressure servo valve 44 is a valve of four ports and three positions in which a solenoid 44d is provided in one end and a return spring 44e is provided in the other end. The water pressure servo valve 44 has a first communication position 44a that is applied when the solenoid 44d is not electrified, a neutral position 44b that is applied when the solenoid 44d is electrified, and a second communication position 44c that is applied when the solenoid 44d is electrified with a further large electric current. In a state where the solenoid 44d is not electrified, the water pressure servo valve 44 is held in the first communication position 44a by biassing force of the return spring 44e.

In the water pressure servo valve 44, a pressure sensor not shown is built and used together with a stroke sensor not shown that is provided in the water pressure cylinder 4 for feedback control thereof. In combination with these sensors, the water pressure servo valve 44 enables precise position control of the water pressure cylinder 4.

An on/off valve 47 and a water pressure meter 49 are provided between the water pressure servo valve 44 and the piston side chamber 4c of the water pressure cylinder 4. Similarly, an on/off valve 48 and a water pressure meter 50 are provided between the water pressure servo valve 44 and the rod side chamber 4d of the water pressure cylinder. Adjustment of the water pressure servo valve 44 to the neutral position can be performed by electrifying the solenoid 44d of the water pressure servo valve 44 in such a manner that the pressures of the working waters detected by the water pressure meters 49, 50 become the same in a state where the on/off valves 47, 48 are in the closed positions.

The switching valve 51 is an electromagnetic switching valve of four ports and three positions in which solenoids and centering springs are provided in both ends. The switching valve 51 has a neutral position 51a, a first communication position 51b to which the switching valve is switched when one of the solenoids is electrified, and a second communication position 51c to which the switching valve is switched when the other solenoid is electrified. In a state where both the pair of solenoids is not electrified, the switching valve 51 is switched to the neutral position 51a by biassing force of the centering springs. The switching valve 51 is of a closed center type in which all the ports are brought into a closed state at the neutral position 51a.

When the switching valve 51 is switched to the first communication position 51b, the switching valve supplies the working water accumulated in the accumulator 30 to the piston side chamber 4c of the water pressure cylinder 4 and provides communication between the rod side chamber 4d and the tank 10. Accordingly, in the water pressure cylinder 4, the piston rod 4e is retreated from the cylinder main body 4a and extended.

Meanwhile, when the switching valve 51 is switched to the second communication position 51c, the switching valve supplies the working water accumulated in the accumulator 30 to the rod side chamber 4d of the water pressure cylinder 4 and provides communication between the piston side chamber 4c and the tank 10. Accordingly, in the water pressure cylinder 4, the piston rod 4e is brought into the cylinder main body 4a and contracted.

In such a way, when the switching valve 51 is switched to the first communication position 51b or the second communication position 51c, the working water accumulated in the accumulator 30 is supplied to the piston side chamber 4c or the rod side chamber 4d of the water pressure cylinder 4. As a result, a great amount of the working water is supplied from the accumulator 30 in a short time. Thus, the water pressure cylinder 4 can swiftly be extended and contracted.

Next, operations of the water pressure system 100 will be described.

For the water pressure cylinders 1 to 3 to be extended and contracted, a relatively low flow rate of the working water is required. Meanwhile, for the water pressure cylinder 4 to be extended and contracted, a high flow rate of the working water is required in comparison to the water pressure cylinders 1 to 3.

Firstly, a case where the water pressure cylinders 1 to 3 are operated by the working water discharged from the water pressure pump 11 and the working water discharged from the water pressure pump 12 is accumulated in the accumulator 30 will be described.

The on/off valve 35 is switched to the blocking position 35b for guiding the working water discharged from the water pressure pump 12 to the accumulator 30. The on/off valve 34 is switched to the communication position 34a and provides communication between the supply passage 14 and the accumulator 30 via the branch passage 31. The switching valve 51 is held in the neutral position 51a by the biassing force of the pair of centering springs and blocks communication between the branch passage 31 and the water pressure cylinder 4. In this state, by switching the switching valve 41, the switching valve 42, and the switching valve 43, the water pressure cylinders 1 to 3 can be operated using the working water discharged from the water pressure pump 11.

It should be noted that at this time, by switching not only the switching valve 41, the switching valve 42, and the switching valve 43 but also the water pressure servo valve 44, the water pressure cylinders 1 to 3 and the water pressure cylinder 4 may be operated simultaneously by the working water discharged from the water pressure pump 11.

Meanwhile, the working water discharged from the water pressure pump 12 is guided to the branch passage 31 through the check valve 32, and supplied to the accumulator 30 through the on/off valve 34. The working water is thereby accumulated in the accumulator 30.

In such a way, in the water pressure system 100, while supplying the working water discharged from the water pressure pump 11 to the water pressure cylinders 1 to 3, the working water discharged from the water pressure pump 12 is supplied to and accumulated in the accumulator 30 for an occasion when it is supplied to the water pressure cylinder 4. In this way, by operating the water pressure pump 11 and the water pressure pump 12 together, the accumulation can be made in the accumulator 30 while driving the water pressure cylinders 1 to 3.

Next, a case where the water pressure cylinder 4 is extended by the working waters discharged from the water pressure pump 11 and the water pressure pump 12, i.e., a case where the water pressure cylinder is operated in one direction, will be described.

In a case where the water pressure cylinder 4 is extended, the piston rod 4e of the water pressure cylinder 4 is moved to an initial position set in advance by switching the switching valve 51 prior to control by the water pressure servo valve 44. Since a considerably high pilot pressure is required for switching the water pressure servo valve 44, use of the working water accumulated in the accumulator 30 is more efficient to adjust the water pressure cylinder 4 to the initial position. In the water pressure system 100, after the water pressure cylinder 4 is adjusted to the initial position, the control by the water pressure servo valve 44 is started.

The on/off valve 35 is maintained at the communication position 35a for supplying the working water discharged from the water pressure pump 12 to the water pressure cylinder 4. Meanwhile, the on/off valve 34 is maintained at the blocking position 34b to block communication between the branch passage 31 and the accumulator 30. The switching valve 51 is held in the neutral position 51a by the biassing force of the pair of centering springs and blocks communication between the branch passage 31 and the water pressure cylinder 4. In this state, by switching the water pressure servo valve 44, the water pressure cylinder 4 can be operated by a high flow rate of the working waters discharged from the water pressure pump 11 and the water pressure pump 12.

Specifically, by switching the water pressure servo valve 44 to the first communication position 44a, in the water pressure cylinder 4, the piston rod 4e is retreated from the cylinder main body 4a by a predetermined distance set for a unit time. At this time, both the on/off valve 47 and the on/off valve 48 are switched to opened positions. The water pressure cylinder 4 thus extended by the predetermined distance set for the unit time can push out an object at a constant pace.

It should be noted that by switching not only the water pressure servo valve 44 but also the switching valve 41, the switching valve 42, or the switching valve 43, the water pressure cylinder 4 and the water pressure cylinders 1 to 3 may be operated simultaneously by the working waters discharged from the water pressure pump 11 and the water pressure pump 12. At this time, since both the working waters discharged from the water pressure pump 11 and the water pressure pump 12 are supplied, shortage in a flow rate of the working water is prevented.

Next, a case where the water pressure cylinder 4 is contracted by the working water accumulated in the accumulator 30, i.e., a case where the water pressure cylinder is operated in another direction, will be described.

Herein, the on/off valve 34 is switched to the communication position 34a for supplying the working water accumulated in the accumulator 30 to the water pressure cylinder 4 through the branch passage 31. The on/off valve 35 is switched to the blocking position 35b so that the working water is not supplied to the water pressure cylinders 1 to 4. The switching valve 51 is switched to the second communication position 51c, provides communication between the branch passage 31 and the rod side chamber 4d of the water pressure cylinder 4, and provides communication between the piston side chamber 4c and the tank 10.

In this state, by supplying the working water accumulated in the accumulator 30 to the rod side chamber 4d, the piston rod 4e is brought into the cylinder main body 4a. Therefore, the water pressure cylinder 4 is contracted. As described above, the accumulator 30 can supply a great amount of the working water in a short time in comparison to the water pressure pumps 11, 12. Therefore, the water pressure cylinder 4 is swiftly contracted in comparison to a case where it is contracted by the working waters discharged from the water pressure pumps 11, 12.

As described above, the water pressure cylinder 4 is extended by the predetermined distance set for the unit time by controlling the water pressure servo valve 44, and contracted to the initial position by switching the switching valve 51. As a result, the water pressure cylinder 4 is extended to push out the object at the constant pace, and when reaching a push-out end, swiftly contracted to the initial position. Since a time for returning the water pressure cylinder 4 to the initial position can be shortened, a time required for replacing the object to be pushed out can be shortened.

According to the above embodiment, the following effects are obtained.

By including the water pressure pump 11 configured to discharge the working water that operates the water pressure cylinders 1 to 3 and the water pressure pump 12 configured to discharge the working water to be accumulated in the accumulator 30, the accumulation can be made in the accumulator 30 while driving the water pressure cylinders 1 to 3 by operating the water pressure pump 11 and the water pressure pump 12 together.

The water pressure cylinder 4 is extended by the predetermined distance set for the unit time by controlling the water pressure servo valve 44, and contracted to the initial position by switching the switching valve 51. Therefore, the water pressure cylinder 4 is extended to push out the object at the constant pace, and when reaching the push-out end, the water pressure cylinder 4 is swiftly contracted to the initial position. Thus, the time for returning the water pressure cylinder 4 to the initial position can be shortened, and the time required for replacing the object to be pushed out can also be shortened.

Although the present invention has been described above with reference to a certain embodiment, the present invention is not limited to the embodiment described above.

For example, in the above embodiment, the water pressure cylinder 4 is extended by the working waters discharged from the water pressure pump 11 and the water pressure pump 12, and contracted by the working water supplied from the accumulator 30. Alternatively, the water pressure cylinder 4 may be configured to contract by the working waters discharged from the water pressure pump 11 and the water pressure pump 12 and extend by the working water supplied from the accumulator 30.

The water pressure cylinder 4 may be extended and contracted using only the accumulated working water supplied from the accumulator 30 by switching the switching valve 51. In this case, when the switching valve 51 is switched to the first communication position 51b, the water pressure cylinder 4 is extended, and when the switching valve 51 is switched to the second communication position 51c, the water pressure cylinder 4 is contracted. When the switching valve 51 is switched to the neutral position 51a, extension and contraction of the water pressure cylinder 4 are stopped.

The contents of Tokugan 2014-118102, with a filing date of Jun. 6, 2014 in Japan, are hereby incorporated by reference. The embodiment of this invention in which an exclusive property or privilege is claimed is defined as follows:

1. A fluid pressure system of supplying a working fluid, comprising:
a first fluid pressure pump configured to discharge a working fluid to operate a fluid pressure actuator;
a second fluid pressure pump provided in parallel with the first fluid pressure pump and configured to discharge a working fluid;
an accumulator capable of accumulating the working fluid discharged from the second fluid pressure pump; and
a first switching valve configured to supply the working fluid accumulated in the accumulator to the fluid pressure actuator when the first switching valve is switched to an open state.

2. The fluid pressure system according to claim 1, further comprising:
a second switching valve provided in a passage communicating the second fluid pressure pump and the fluid pressure actuator in parallel to the first switching valve, wherein the second switching valve is configured to supply the working fluid discharged from the second fluid pressure pump to the fluid pressure actuator when the second switching valve is switched to an open state.

3. The fluid pressure system according to claim 2, further comprising:
a third switching valve configured to open and close a passage communicating with the accumulator, wherein
the third switching valve is switched to a closed state when the second switching valve is switched to an opened state, and switched to an opened state when the second switching valve is switched to a closed state.

4. The fluid pressure system according to claim 1, further comprising:
a passage providing communication between the second fluid pressure pump and the fluid pressure actuator,
wherein the fluid pressure actuator is operated in one direction by the working fluid discharged from the first fluid pressure pump or the working fluid discharged from the first fluid pressure pump and the second fluid pressure pump, and operated in another direction by the working fluid supplied from the accumulator.

5. The fluid pressure system according to claim 1, wherein the first fluid pressure pump and the second fluid pressure pump are driven by a single electric motor.

6. An accumulation method of an accumulator, comprising:
supplying a working fluid discharged from a first fluid pressure pump to a fluid pressure actuator while accumulating a working fluid discharged from a second fluid pressure pump which is provided in parallel to the first fluid pressure pump for supplying an accumulated working fluid to the fluid pressure actuator.

7. An operation method of a fluid pressure actuator, comprising:
supplying a working fluid discharged from a first fluid pressure pump to the fluid pressure actuator while accumulating a working fluid discharged from a second fluid pressure pump which is provided in parallel to the first fluid pressure pump in an accumulator;
operating the fluid pressure actuator in one direction by supplying the working fluid discharged from the first fluid pressure pump to the fluid pressure actuator; and
operating the fluid pressure actuator in another direction by supplying the working fluid accumulated in the accumulator.
